(19) United States
(12) Patent Application Publication
(10) Pub. No.: US 2024/0007732 A1
(43) Pub. Date: Jan. 4, 2024

(54) ELECTRONIC DEVICE INCLUDING PLURALITY OF CAMERAS

(71) Applicant: Samsung Electronics Co., Ltd., Suwon-si (KR)

(72) Inventor: Taekseong JEONG, Suwon-si (KR)

(73) Assignee: Samsung Electronics Co., Ltd., Suwon-si (KR)

(21) Appl. No.: 18/368,978

(22) Filed: Sep. 15, 2023

Related U.S. Application Data
(63) Continuation of application No. PCT/KR2022/003987, filed on Mar. 22, 2022.

(30) Foreign Application Priority Data
Mar. 24, 2021 (KR) 10-2021-0038008

(51) Int. Cl. H04N 23/61; G06T 5/00; G06T 5/50; H04N 23/63; H04N 23/69; H04N 23/695

(52) U.S. Cl. CPC H04N 23/61; G06T 5/002; G06T 5/50; H04N 23/632; H04N 23/69; H04N 23/695; G06T 2207/20221

(57) ABSTRACT

An electronic device includes a first camera having a first view angle; a second camera having a second view angle that is smaller than the first view angle; a display; a memory; and a processor configured to: apply a first tuning parameter to first image data obtained by the first camera; recognize an external object; control, by driving the second camera, a center of the second view angle to be oriented toward the recognized external object; and apply, to the first image data, a second tuning parameter corresponding to a location of the center of the second view angle.

### CROSS-REFERENCE TO RELATED APPLICATIONS

This application is by-pass continuation application of International Application No. PCT/KR2022/003987, filed on Mar. 22, 2022, which based on and claims priority to Korean Patent Application No. 10-2021-0038008, filed on Mar. 24, 2021, in the Korean Intellectual Property Office, the disclosures of which are incorporated by reference herein in their entireties.

### BACKGROUND

### 1. Field

The disclosure relates to an electronic device including a plurality of cameras and an image processing method.

### 2. Description of Related Art

An electronic device such as a smartphone or a tablet personal computer (PC) may include a camera module (which may be a camera or other imaging device). The camera module may obtain image data through an image sensor. The image data may be stored in a memory of the electronic device or may be output through a display thereof.

Nowadays, an electronic device equipped with a multi-camera module is being released. The multi-camera module may include a plurality of cameras having different optical characteristics. For example, the multi-camera module may include a wide-angle camera and a telephoto camera. Each of the wide-angle camera and the telephoto camera may obtain image data.

The multi-camera module may include a camera that supports a function to scan an object. For example, the telephoto camera of a multi-camera module may include a prism or mirror therein. The telephoto camera of the multi-camera module may rotate or move the prism or mirror through a driving unit. In this case, a direction in which the telephoto camera is oriented may be different from a direction in which the wide-angle camera is oriented.

An electronic device may be used by switching between a wide-angle camera and a telephoto camera in response to zoom magnification, a distance to an object, or a change in illumination. For example, the electronic device may output a preview image by using a wide-angle camera at a magnification of less than 5×, and may output the preview image by using a telephoto camera at a magnification of 5× or more.

When the telephoto camera supports a function to scan an external object, the center of a view angle of the telephoto camera may be moved to face the external object. For example, while the external object is positioned in a peripheral region rather than a central region of the wide-angle camera, a center direction of the wide-angle camera may be different from a center direction of the telephoto camera. In this state, when the wide-angle camera is switched to the telephoto camera, the quality level of the preview image changes greatly, and thus may provide a user with the sense of difference.

### SUMMARY

Provided are an electronic device that changes a tuning parameter for image data of the wide-angle camera in conjunction with a location of a center of a view angle of the telephoto camera.

According to an aspect of an example embodiment, an electronic device includes: a first camera having a first view angle; a second camera having a second view angle that is smaller than the first view angle; a display; a memory; and a processor configured to: apply a first tuning parameter to first image data obtained by the first camera; recognize an external object; control, by driving the second camera, a center of the second view angle to be oriented toward the recognized external object; and apply, to the first image data, a second tuning parameter corresponding to a location of the center of the second view angle.

The processor may be further configured to, based on the first camera being set to a specified magnification or more, apply the second tuning parameter to the first image data.

The processor may be further configured to: divide the first view angle into a plurality of sections; and store, in a lookup table of the memory, the second tuning parameter corresponding to each of the plurality of sections.

The processor may be further configured to, based on a movement of the center of the second view angle, obtain the second tuning parameter from the lookup table.

The processor may be further configured to, while applying the second tuning parameter to the first image data, apply a third tuning parameter to second image data obtained by the second camera.

The processor may be further configured to output a preview image to the display, the preview image representing the first image data to which the second tuning parameter is applied.

The processor may be further configured to, based on a specified condition related to switching of the first camera and the second camera occurring, output the preview image to the display according to second image data obtained by the second camera.

The processor may be further configured to output a preview image to the display, the preview image representing second image data obtained by the second camera.

The processor may be further configured to, based on a specified condition related to switching of the first camera and the second camera occurring, output the preview image to the display, the preview image representing the first image data to which the second tuning parameter is applied.

The processor may be further configured to, based on the external object being recognized beyond a specified range from a center of the first view angle, apply the second tuning parameter to the first image data.

The second camera may include a folded camera structure including a prism, and the processor may be further configured to control, by driving the second camera, at least one of movement and rotation of the prism of the second camera.

The processor may be further configured to control, by driving the second camera, the second view angle to be within the first view angle.

Each of the first tuning parameter and the second tuning parameter may include a parameter related to at least one of noise reduction (NR), edge enhance, or multi-frame merge.

Each of the first tuning parameter and the second tuning parameter may include a deep learning model related to sharpness.

According to an aspect of the disclosure, an image processing method performed by an electronic device, includes: applying a first tuning parameter to first image data obtained by a first camera of the electronic device; recognizing an external object; controlling, by driving a second camera of the electronic device, a center of a second view angle of the second camera to be oriented toward the recognized external object; and applying, to the first image data, a second tuning parameter corresponding to a location of the center of the second view angle.

According to various embodiments, an electronic device may include a first camera module having a first view angle, a second camera module having a second view angle smaller than the first view angle, a display, a memory, and a processor. The processor may apply a first tuning parameter to first image data obtained by a first camera module, may recognize an external object, may control a driving unit of the second camera module such that a center of a second view angle is oriented toward the recognized external object, and may apply, to the first image data, a second tuning parameter corresponding to a location of the center of the second view angle.

According to one or more embodiments of the disclosure, an electronic device may change an image tuning parameter of a wide-angle camera in conjunction with a location of the center of a view angle of a telephoto camera, thereby reducing the sense of difference of image switching capable of occurring during camera switching.

The electronic device according to one or more embodiments of one or more embodiments may improve issues indicating that an image quality difference increases depending on a scan location of the telephoto camera during camera switching.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment, according to one or more embodiments;

FIG. 2 is a block diagram illustrating a camera module, according to one or more embodiments;

FIG. 3 illustrates an electronic device including a multi-camera module, according to one or more embodiments;

FIG. 4 illustrates a first view angle of a first camera and a second view angle of a second camera, according to one or more embodiments;

FIG. 5 illustrates an image processing method, according to one or more embodiments;

FIG. 6 illustrates an image processing method in a zoom-in process, according to one or more embodiments;

FIG. 7 illustrates an image processing method in a zoom-out process, according to one or more embodiments;

FIG. 8 is an exemplary view of changing a tuning parameter, according to one or more embodiments;

FIG. 9 illustrates conversion of a preview image in a central region, according to one or more embodiments; and

FIG. 10 illustrates conversion of a preview image in a surrounding region, according to one or more embodiments.

### DETAILED DESCRIPTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to the description of drawings, same or similar components may be marked by same or similar reference marks/numerals.

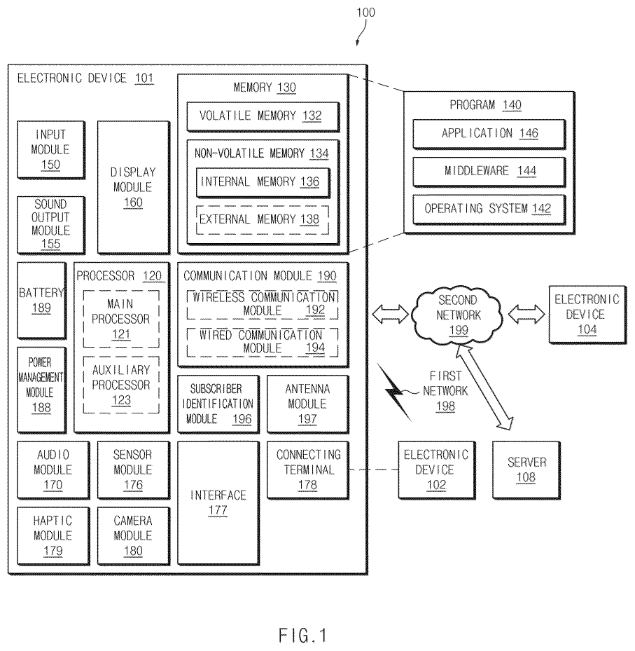

FIG. 1 is a block diagram illustrating an electronic device 101 in a network environment 100 according to one or more embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic device 102 or the external electronic device 104 may be a device of a same type as, or a different type, from the electronic device 101. According to an embodiment, all or some of operations to be executed at the electronic device 101 may be executed at one or more of the external electronic device 102, the external electronic device 104, or the external electronic device 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

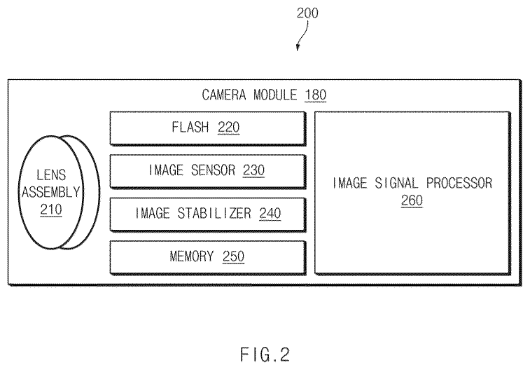

FIG. 2 is a block diagram 200 illustrating the camera module 180 according to one or more embodiments.

Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment, the camera module 180 may include a plurality of lens assemblies, including the lens assembly 210. In such a case, the camera module 180 may form, for example, a dual camera, a 360-degree camera, or a spherical camera. Some of the plurality of lens assemblies, including the lens assembly 210, may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor or an acceleration sensor disposed inside or outside the camera module 180. According to an embodiment, the image stabilizer 240 may be implemented, for example, as an optical image stabilizer. The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display device 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display device 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display device 160 as the at least one image is or after being further processed.

According to an embodiment, the electronic device (101) may include a plurality of camera modules, including the camera module 180, having different attributes or functions. For example, a plurality of camera modules, including the camera module 180, including lenses (e.g., the lens assembly 210) having different view angles may be provided, and based on user selection, the electronic device 101 may perform control to use the wide angle of the camera module 180 related to the user selection. For example, at least one of the plurality of camera modules, including the camera module 180, may be a wide-angle camera and at least another one of the plurality of camera modules, including the camera module 180, may be a telephoto camera. Similarly, at least one of the plurality of camera modules, including the camera module 180, may be a front camera and at least another one of the plurality of camera modules, including the camera module 180, may be a rear camera. Furthermore, the plurality of camera modules, including the camera module 180, may include at least one of a wide-angle camera, a telephoto camera, a color camera, a black and white camera, or an infrared (IR) camera (e.g., a time of flight (TOF) camera or a structured light camera). According to an embodiment, the IR camera may operate as at least part of a sensor module (e.g., the sensor module 176 of FIG. 1). For example, the TOF camera may operate as at least part of a sensor module (e.g., the sensor module 176 of FIG. 1) for sensing the distance to an object.

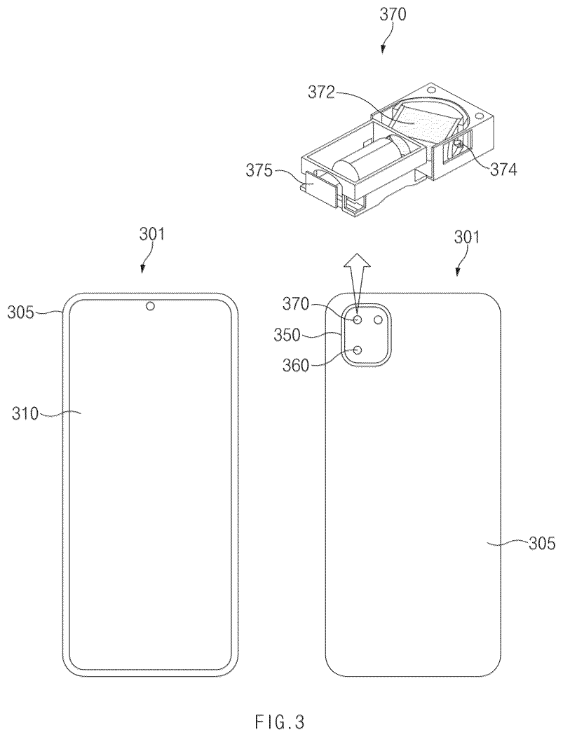

FIG. 3 illustrates an electronic device including a multi-camera module, according to one or more embodiments.

Referring to FIG. 3, an electronic device 301 may include a housing 305, a display 310, and a multi-camera module 350. The electronic device 301 may additionally include a configuration such as a button, a sensor, or a microphone.

The housing 305 (or a body part) may mount the display 310, the multi-camera module 350, an ambient button, and the like and may include a configuration such as a processor, a memory, a sensor module, a printed circuit board, and a battery. In FIG. 3, the multi-camera module 350 is illustrated as being mounted on a rear surface of the housing 305 (a surface opposite to a surface on which the display 310 is positioned). However, embodiments of the disclosure may not be limited thereto. For example, the multi-camera module 350 may be mounted on a front surface (a surface where the display 310 is positioned) of the housing 305.

The display 310 may output various pieces of content to be provided to a user and may receive an input of the user through a touch input. The display 310 may output a preview image based on image data collected through the multi-camera module 350. While identifying the preview image output through the display 310 in real time, the user may photograph a photo or a video.

According to one or more embodiments, the multi-camera module (or multi-camera device) 350 may include a first camera module (or a first camera) 360 and a second camera module (or a second camera) 370. The first camera module 360 and the second camera module 370 may be positioned to face the same direction, and may be positioned to maintain a specified distance (e.g., 1 cm). FIG. 3 illustrates that the first camera module 360 and the second camera module 370 are positioned in a vertical direction, but embodiments of the disclosure are not limited thereto.

According to one or more embodiments, the first camera module 360 may be a wide-angle camera. The first camera module 360 may have a relatively large view angle (hereinafter, a first view angle) which is relatively large compared to at least that of a “second view angle” noted below. The first camera module 360 may be equipped with a wide-angle lens suitable to capture a subject at a near distance.

The second camera module 370 may be a telephoto camera. The second camera module 370 may have a relatively small view angle (hereinafter referred to as a “second view angle”) which is relatively small compared to at least that of the first view angle. The second camera module 370 may be equipped with a telephoto lens suitable to capture the subject at a long distance.

According to one or more embodiments, the second camera module 370 may scan an external object. For example, the second camera module 370 may be a folded camera, and may include a prism 372 (or mirror) and a driving unit 374 that moves or rotates the prism 372 therein. As the driving unit 374 moves, the center of the second view angle of the second camera module 370 (hereinafter, referred to as a “second view angle center”) may move. The electronic device 301 may control the driving unit 374 such that the object to be scanned is positioned at the second view angle center. When the object's location is moved, the second view angle center may be continuously oriented toward the object through image analysis under control of the electronic device 301. FIG. 3 illustrates that the second camera module 370 is a folded camera, but the disclosure is not limited thereto.

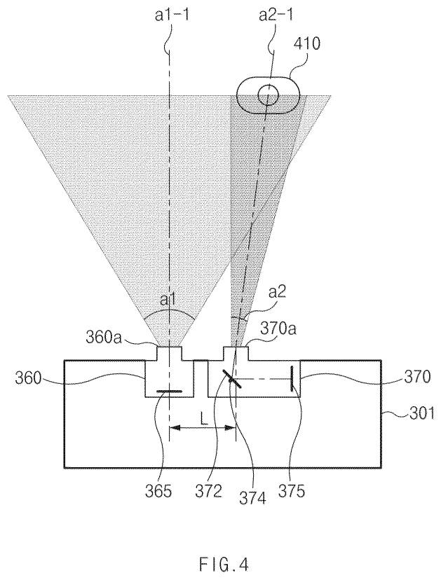

FIG. 4 illustrates a first view angle of a first camera module and a second view angle of a second camera module, according to one or more embodiments.

Referring to FIG. 4, the electronic device 301 may include the first camera module 360 (or a first camera) and the second camera module 370 (or a second camera). The first camera module 360 and the second camera module 370 may be positioned to be spaced from each other by a specified interval ‘L’. The first camera module 360 and the second camera module 370 may be positioned such that openings 360a and 370a, each of which collects light, face the same direction as each other.

According to one or more embodiments, the first camera module 360 may be a wide-angle camera. The first camera module 360 may have a relatively large first view angle a1 (e.g., 80 degrees to 100 degrees). The first camera module 360 may be implemented as a direct-typed optical system that does not include a separate prism or mirror. The first camera module 360 may have a center a1-1 of the first view angle a1 (hereinafter, referred to as a “first view angle center”). The first view angle center a1-1 may face a fixed direction within the first view angle a1.

A first image sensor 365 of the first camera module 360 may convert light into electronic image data through a photoelectric conversion effect. The first image sensor 365 may include a group of pixels arranged two-dimensionally and may convert light into electronic image data at each pixel. The first image sensor 365 may be positioned to face the opening 360a through which light is introduced. The light introduced through the opening 360a may be directly incident on the first image sensor 365.

According to one or more embodiments, the second camera module 370 may be a telephoto camera. The second camera module 370 may have a relatively small second view angle a2 (e.g., 30 degrees).

According to one or more embodiments, the second camera module 370 may be a folded camera. The second camera module 370 may include the prism (or mirror) 372, the driving unit 374 for moving the prism 372, and a second image sensor 375 therein. A second view angle center a2-1 of the second camera module 370 may move depending on the movement of the driving unit 374.

The second image sensor 375 may convert light into electronic image data through a photoelectric conversion effect. The second image sensor 375 may include a group of pixels arranged two-dimensionally and may convert light into electronic image data at each pixel. The second image sensor 375 may not face the opening 370a through which light is introduced. The light introduced through the opening 370a is reflected by the prism (or mirror) 372 and may be incident on the second image sensor 375.

According to one or more embodiments, the second camera module 370 may scan an object 410. The electronic device 301 may control the driving unit 374 such that the object 410 to be scanned is positioned at the second view angle center a2-1. When the location of the object 410 is changed, the electronic device 301 may continuously track the object 410 such that the object 410 is positioned at the second view angle center a2-1.

In an embodiment, within a range where the second view angle a2 is positioned within the first view angle a1 of the first camera module 360, the second camera module 370 may scan the object 410.

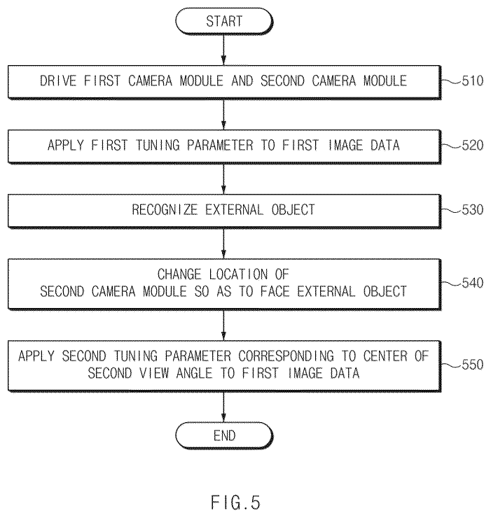

FIG. 5 illustrates an image processing method, according to one or more embodiments.

Referring to FIG. 5, in operation 510, a processor (e.g., the processor 120 in FIG. 1) (or the image signal processor 260 of FIG. 2, hereinafter, the processor is the same as the image signal processor 260 of FIG. 2) may drive the first camera module 360 and the second camera module 370.

The first camera module 360 may be a wide-angle camera having a first view angle. The first camera module 360 may obtain image data (hereafter, referred to as “first image data”) through the first image sensor 365.

The second camera module 370 may be a telephoto camera having a second view angle. The second camera module 370 may obtain image data (hereafter, referred to as “second image data”) through the second image sensor 375.

In an embodiment, the processor 120 may output a preview image on a display by using at least one of the first image data and the second image data. For example, at a specified reference magnification or lower, the processor 120 may output an image (hereinafter, referred to as a “first image”) generated by using the first image data as a preview image. At the specified reference magnification is exceeded, the processor 120 may output an image (hereinafter, referred to as a “second image”) generated by using the second image data as the preview image.

In operation 520, the processor 120 may apply a first tuning parameter, which is preset in conjunction with the first camera module 360, to the first image data. The first tuning parameter may be a value determined regardless of a location of the second camera module 370. For example, the first tuning parameter may be a parameter related to noise reduction (NR), sharpen, or multi-frame merge. For another example, the first tuning parameter may be a deep learning model related to sharpness.

In operation 530, the processor 120 may recognize an external object. The processor 120 may determine a location of the external object by analyzing the first image data or the second image data. For example, the processor 120 may determine the location of the external object by using various object recognition methods such as feature point analysis and edge analysis. For another example, the processor 120 may recognize the external object by using information obtained through a separate sensor.

According to one or more embodiments, when a plurality of objects are recognized, the processor 120 may determine a main object under a specified condition. For example, the processor 120 may determine, as the main object, the largest object, an object without motion, or an object frequently recognized in a stored image from among a plurality of objects.

In operation 540, the processor 120 may change the location of the second camera module such that the second view angle center of the second camera module faces the external object. For example, when the second camera module 370 is a folded camera as shown in FIG. 3 or FIG. 4, the processor 120 may allow the driving unit 374 to move or rotate the prism 372. The processor 120 may control the driving unit 374 such that the object to be scanned is positioned at the second view angle center.

In operation 550, the processor 120 may apply a second tuning parameter, which is preset in conjunction with the location of the second view angle center of the second camera module, to the first image data. For example, the second tuning parameter may be a parameter related to NR, sharpen, or multi-frame merge. For another example, the second tuning parameter may be a deep learning model related to sharpness. The second tuning parameter may be set based on an absolute value or may be set to a relative ratio.

In an embodiment, the processor 120 may determine a region (hereafter, referred to as an “object placement region”) corresponding to the location of the second view angle center in the first image of the first camera module 360. The object placement region may be a region in which an external object being scanned by the second camera module 370 is placed in the first image. The processor 120 may apply the second tuning parameter to the object placement region of the first image and may apply the first tuning parameter to another region thereof.

According to one or more embodiments, the processor 120 may divide the first view angle (or the first image) of the first camera module 360 into a plurality of sections, and may set a tuning parameter set corresponding to each section. For example, the processor 120 may store the tuning parameter set for each section as a lookup table LUT. The look-up table LUT may be stored based on a signal obtained from a sensor module.

When the second view angle center moves by scanning the external object, the processor 120 may determine a section of a first view angle corresponding to a second view angle center among the plurality of sections. The processor 120 may apply a tuning parameter set corresponding to the determined section to first image data with reference to the lookup table. The processor 120 may apply a changed tuning parameter set to the determined section and may maintain the existing tuning parameters for another section regardless of the second camera.

According to one or more embodiments, the processor 120 may identify a specified condition related to the switching of a camera. For example, the condition may be a condition that the zoom magnification is changed to exceed a specified reference value (zoom-in) or changed to the specified reference value or less (zoom-out). For another example, the condition may be set in conjunction with a distance from the object or a change in illuminance.

For example, at the magnification of 2×, the processor 120 may output a preview image through the first image of the first camera module 360. When a zoom-in input occurs and then the magnification is changed to 5× that is capable of being processed by the second camera module 370, the processor 120 may output a preview image through the second image of the second camera module 370 by switching a main camera. In a zoom-in process, the processor 120 may zoom in an image based on an object being scanned by the second camera module 370.

In a state before the camera is switched, the object placement region of the first image may be in a state where the second tuning parameter reflecting the second view angle center is applied. Before and after a camera is switched, the object placement region of the first image and the second image may have a similar level of sharpness to each other. Accordingly, before and after a camera is switched, a difference in image quality may not be large.

For example, at the magnification of 5×, the processor 120 may output the preview image through the second image of the second camera module 370. When a zoom-out input occurs and then the magnification is changed to 2× that is capable of being processed by the first camera module 360, the processor 120 may output a preview image through the first image of the first camera module 360 by switching a main camera. In a zoom-out process, the processor 120 may zoom out an image based on an object being scanned by the second camera module 370.

In a state before the camera is switched, the object placement region of the first image may be in a state where the second tuning parameter reflecting the second view angle center is applied. Before and after a camera is switched, the second image and the object placement region of the first image may have a similar level of sharpness to each other. Accordingly, before and after a camera is switched, a difference in image quality may not be large.

In an embodiment, the processor 120 may perform image processing using a tuning parameter only on a camera determined as the main camera. For example, when the first camera module 360 is determined as the main camera, the processor 120 may apply a second tuning parameter reflecting a second view angle center to the first image data of the first camera module 360.

In another embodiment, before the main camera is determined, the processor 120 may perform image processing using a tuning parameter on each of the first camera module 360 and the second camera module 370. The second tuning parameter reflecting the second view angle center may be applied to the first camera module 360. A separate third tuning parameter may be applied to the second camera module 370. When the main camera is determined afterward, the preview image may be output as an image captured by the determined camera.

According to one or more embodiments, when the object placement region is a region (hereinafter referred to as a “central region”) within a specified range from the center of the first view angle, the processor 120 may not apply the second tuning parameter to the object placement region. When the object placement region is a region (hereafter referred to as a “surrounding region”) other than the central region of the first image, the processor 120 may apply the second tuning parameter to the object placement region.

According to one or more embodiments, at a specified magnification or lower (e.g., 1× or lower), the processor 120 does not apply the second tuning parameter to the first image data. When the specified magnification is exceeded, the processor 120 may apply the second tuning parameter to the first image data.

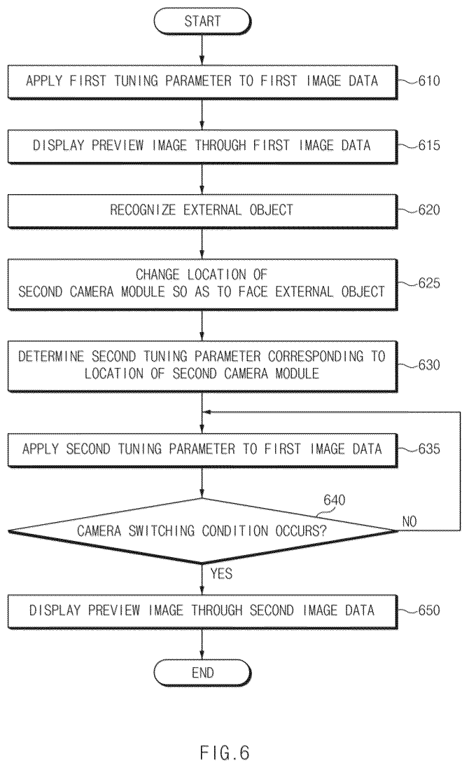

FIG. 6 illustrates an image processing method in a zoom-in process, according to one or more embodiments.

Referring to FIG. 6, in operation 610, the processor 120 may apply a first tuning parameter to first image data. The first tuning parameter may be a parameter value preset for the first camera module 360 regardless of a location of the second view angle center. For example, the processor 120 may apply a specified parameter set value according to basic settings to the first image data.

In operation 615, the processor 120 may display a preview image by using the first image data obtained through the first camera module 360.

In operation 620, the processor 120 may recognize an external object. The processor 120 may determine a location of the external object by analyzing the first image data.

In operation 625, the processor 120 may change the location of the second camera module 370 such that the second view angle center of the second camera module 370 faces the external object.

In operation 630, the processor 120 may determine a second tuning parameter corresponding to the location of the second camera module. For example, the processor 120 may pre-store a tuning parameter set for each of a plurality of sections constituting a first view angle (or a first image) as a look-up table LUT. The processor 120 may determine the second tuning parameter corresponding to the second view angle center with reference to the lookup table LUT.

In operation 635, the processor 120 may apply the second tuning parameter to the first image data. For example, the processor 120 may apply the second tuning parameter to the entire first image. For another example, the processor 120 may apply the second tuning parameter to only an object placement region of the first image.

In operation 640, the processor 120 may determine whether a specified condition related to camera switching occurs. For example, the condition may be a condition that zoom magnification is changed to exceed a specified reference value (zoom-in).

When the specified condition related to camera switching occurs, in operation 650, the processor 120 may display the preview image by using second image data obtained through the second camera module 370.

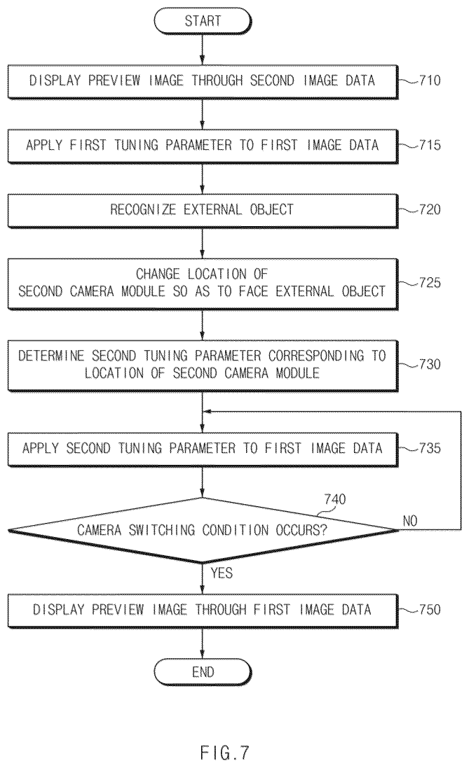

FIG. 7 illustrates an image processing method in a zoom-out process, according to one or more embodiments.

Referring to FIG. 7, in operation 710, the processor 120 may display a preview image by using second image data obtained through the second camera module 370.

In operation 715, the processor 120 may apply a first tuning parameter to first image data. The first tuning parameter may be a parameter value preset for the first camera module 360 regardless of a location of the second view angle center. For example, the processor 120 may apply a specified parameter set value according to basic settings to the first image data.

In operation 720, the processor 120 may recognize an external object. The processor 120 may determine a location of the external object by analyzing the first image data or the second image data.

In operation 725, the processor 120 may change the location of the second camera module 370 such that the second view angle center of the second camera module 370 faces the external object.

In operation 730, the processor 120 may determine a second tuning parameter corresponding to the location of the second camera module. For example, the processor 120 may pre-store a tuning parameter set for each of a plurality of sections constituting a first view angle (or a first image) as a look-up table LUT. The processor 120 may determine the second tuning parameter corresponding to the second view angle center of the second camera module with reference to the lookup table LUT.

In operation 735, the processor 120 may apply the second tuning parameter to the first image data. For example, the processor 120 may apply the second tuning parameter to the entire first image. For another example, the processor 120 may apply the second tuning parameter to only an object placement region of the first image.

In operation 740, the processor 120 may determine whether a specified condition related to camera switching occurs. For example, the condition may be a condition that zoom magnification is changed to be less than or equal to a specified reference value (zoom-out).

When the specified condition related to camera switching occurs, in operation 750, the processor 120 may display the preview image by using the first image data obtained through the first camera module 360. The second tuning parameter may be applied to the first image data, and a difference in image quality due to camera switching may not be large.

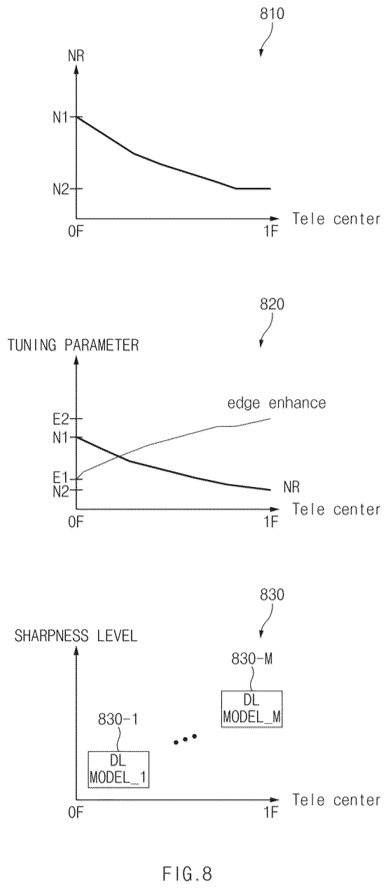

FIG. 8 is an exemplary view of changing a tuning parameter, according to one or more embodiments. FIG. 8 is only an example, and the disclosure is not limited thereto.

Referring to FIG. 8, in a first graph 810, the processor 120 may change a tuning parameter value applied to first image data based on a location of a second view angle center of the second camera module 370.

For example, when the second view angle center is placed at the center of a first image (or first view angle center) (0F), the processor 120 may set a relatively high NR value (N1) to reduce noise in a surrounding region.

When the second view angle center is moved and then placed in the surrounding region (1F) of the first image data, the processor 120 may set a relatively low NR value (N2) to improve the sharpness of the surrounding region. Accordingly, when camera switching occurs, a difference in sharpness between preview images may be small. Accordingly, the sense of difference felt by a user may be reduced.

In a second graph 820, the processor 120 may change a plurality of parameter values applied to the first image data based on a location of a second view angle center of the second camera module 370.

For example, when the second view angle center is placed at the center of a first image (or first view angle center) (0F), the processor 120 may set a relatively high NR value (N1) and a relatively low edge enhance value (E1).

When the second view angle center is moved and then placed in the surrounding region (1F) of the first image data, the processor 120 may set a relatively low NR value (N2) and a relatively high edge enhance value (E2).

In a third graph 830, the processor 120 may change a deep learning model for sharpness applied to the first image data based on the location of the second view angle center of the second camera module 370.

For example, when the second view angle center is placed at the center of a first image (or first view angle center) (0F), the processor 120 may set a first model 830-1 to the first image data. When the second view angle center is moved and then placed in the surrounding region (1F) of the first image data, the processor 120 may set an M-th model 830-M to the second image data.

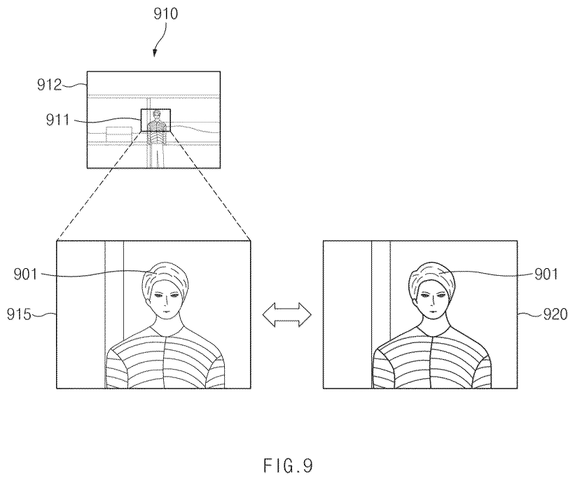

FIG. 9 illustrates conversion of a preview image in a central region, according to one or more embodiments.

Referring to FIG. 9, the first camera module 360 may obtain a first image 910. The second camera module 370 may obtain a second image 920.

In an embodiment, when a zoom-in input occurs while an object 901 is placed in a central region 911 of the first image 910, the processor 120 may convert a first partial image 915, to which a first tuning parameter is applied, to the second image 920. When the object 901 is placed in the central region 911 of the first image 910, a difference in image quality between the first partial image 915 and the second partial image 920 may not be large. Alternatively, when a zoom-out input occurs, the processor 120 may convert the second image 920 to the first partial image 915 to which the first tuning parameter is applied.

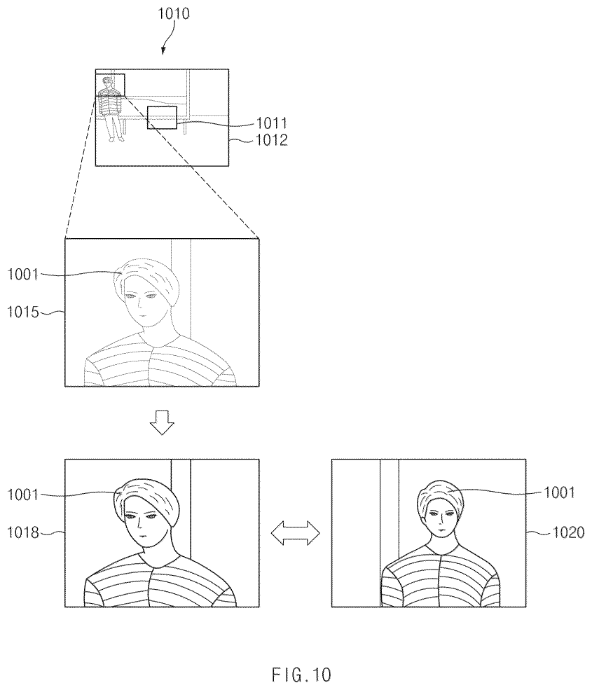

FIG. 10 illustrates conversion of a preview image in a surrounding region, according to one or more embodiments.

Referring to FIG. 10, the first camera module 360 may obtain a first image 1010. The second camera module 370 may obtain a second image 1020.

When an object 1001 is placed in a surrounding region 1012 other than a central region 1011 of the first image 1010, the processor 120 may switch a first partial image 1015, to which a first tuning parameter is applied, to a second partial image 1018 to which a second tuning parameter is applied.

In an embodiment, when a zoom-in input occurs while the object 1001 is placed in the surrounding region 1012 of the first image 1010, the processor 120 may switch the second partial image 1018, to which the second tuning parameter is applied, to a second image 1020. On the other hand, when a zoom-out input occurs, the processor 120 may convert the second image 1020 to the second partial image 1018 to which the second tuning parameter is applied. The second tuning parameter is applied to the second partial image 1018, and thus a difference in image quality due to camera switching may not be large.

According to one or more embodiments, an electronic device (e.g., the electronic device 101 of FIG. 1 or the electronic device 301 of FIG. 3) may include a first camera module (e.g., the camera module 180 of FIG. 1 or the first camera module 360 of FIG. 3) having a first view angle, a second camera module (e.g., the camera module 180 of FIG. 1 or the second camera module 370 of FIG. 3) having a second view angle smaller than the first view angle, a display (e.g., the display module 160 of FIG. 1 or the display 310 of FIG. 3), a memory (e.g., the memory 130 of FIG. 1), and a processor (e.g., the processor 120 of FIG. 1 or the image signal processor 260 of FIG. 2). The processor (e.g., the processor 120 of FIG. 1 or the image signal processor 260 of FIG. 2) may apply a first tuning parameter to first image data obtained by a first camera module (e.g., the camera module 180 of FIG. 1 or the first camera module 360 of FIG. 3), may recognize an external object, may control a driving unit of the second camera module (e.g., the camera module 180 of FIG. 1 or the second camera module 370 of FIG. 3) such that a center of a second view angle is oriented toward the recognized external object, and may apply, to the first image data, a second tuning parameter corresponding to a location of the center of the second view angle.

According to one or more embodiments, the processor (e.g., the processor 120 of FIG. 1 or the image signal processor 260 of FIG. 2) may apply the second tuning parameter to the first image data when the first camera module (e.g., the camera module 180 of FIG. 1 or the first camera module 360 of FIG. 3) has a specified magnification or more.

According to one or more embodiments, the processor (e.g., the processor 120 of FIG. 1 or the image signal processor 260 of FIG. 2) may divide the first view angle into a plurality of sections and may store the second tuning parameter corresponding to each of the plurality of sections in the memory (e.g., the memory 130 of FIG. 1) in a lookup table.

According to one or more embodiments, the processor (e.g., the processor 120 of FIG. 1 or the image signal processor 260 of FIG. 2) may determine the second tuning parameter with reference to the lookup table when the center of the second view angle moves.

According to one or more embodiments, the processor (e.g., the processor 120 of FIG. 1 or the image signal processor 260 of FIG. 2) may apply a third tuning parameter to second image data obtained by the second camera module (e.g., the camera module 180 of FIG. 1 or the second camera module 370 of FIG. 3) while applying the second tuning parameter to the first image data.

According to one or more embodiments, the processor (e.g., the processor 120 of FIG. 1 or the image signal processor 260 of FIG. 2) may output a preview image to the display (e.g., the display module 160 of FIG. 1 or the display 310 of FIG. 3) by using the first image data to which the second tuning parameter is applied.

According to one or more embodiments, the processor (e.g., the processor 120 of FIG. 1 or the image signal processor 260 of FIG. 2) may output the preview image by using second image data obtained through the second camera module (e.g., the camera module 180 of FIG. 1 or the second camera module 370 of FIG. 3) when a specified condition related to switching of a camera occurs.

According to one or more embodiments, the processor (e.g., the processor 120 of FIG. 1 or the image signal processor 260 of FIG. 2) may output a preview image by using the second image data obtained by the second camera module (e.g., the camera module 180 of FIG. 1 or the second camera module 370 of FIG. 3).

According to one or more embodiments, the processor (e.g., the processor 120 of FIG. 1 or the image signal processor 260 of FIG. 2) may output the preview image to the display (e.g., the display module 160 of FIG. 1 or the display 310 of FIG. 3) by using the first image data to which the second tuning parameter is applied, when a specified condition related to switching of a camera occurs.

According to one or more embodiments, the processor (e.g., the processor 120 of FIG. 1 or the image signal processor 260 of FIG. 2) may apply the second tuning parameter to the first image data when the external object is recognized beyond a specified range from a center of the first view angle.

According to one or more embodiments, the second camera module (e.g., the camera module 180 of FIG. 1 or the second camera module 370 of FIG. 3) may include a folded camera structure including a prism. The driving unit may move or rotate the prism of the second camera module (e.g., the camera module 180 of FIG. 1 or the second camera module 370 of FIG. 3).

According to one or more embodiments, the processor (e.g., the processor 120 of FIG. 1 or the image signal processor 260 of FIG. 2) may control the driving unit such that the second view angle moves within the first view angle.

According to one or more embodiments, each of the first tuning parameter and the second tuning parameter may include a parameter related to at least one of NR, edge enhance, or multi-frame merge.

According to one or more embodiments, each of the first tuning parameter and the second tuning parameter may be a deep learning model related to sharpness.

According to one or more embodiments, an image processing method performed in an electronic device (e.g., the electronic device 101 of FIG. 1 or the electronic device 301 of FIG. 3) may include applying a first tuning parameter to first image data obtained by a first camera module (e.g., the camera module 180 of FIG. 1 or the first camera module 360 of FIG. 3) of the electronic device (e.g., the electronic device 101 of FIG. 1 or the electronic device 301 of FIG. 3), recognizing an external object, controlling a driving part of a second camera module (e.g., the camera module 180 of FIG. 1 or the second camera module 370 of FIG. 3) of the electronic device (e.g., the electronic device 101 of FIG. 1 or the electronic device 301 of FIG. 3) such that a center of a second view angle of the second camera module (e.g., the camera module 180 of FIG. 1 or the second camera module 370 of FIG. 3) is oriented toward the recognized external object, and applying, to the first image data, a second tuning parameter corresponding to a location of the center of the second view angle.

According to one or more embodiments, the applying of the second tuning parameter to the first image data may include applying the second tuning parameter to the first image data when the first camera module (e.g., the camera module 180 of FIG. 1 or the first camera module 360 of FIG. 3) has a specified magnification or more.

According to one or more embodiments, the image processing method may further include outputting a preview image by using the first image data to which the second tuning parameter is applied.

According to one or more embodiments, the image processing method may further include outputting the preview image by using second image data obtained through the second camera module (e.g., the camera module 180 of FIG. 1 or the second camera module 370 of FIG. 3) when a specified condition related to switching of a camera occurs.

According to one or more embodiments, the image processing method may further include outputting the preview image by using second image data obtained through the second camera module (e.g., the camera module 180 of FIG. 1 or the second camera module 370 of FIG. 3).

According to one or more embodiments, the image processing method may further include outputting a preview image by using the first image data, to which the second tuning parameter is applied, when a specified condition related to switching of a camera occurs.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a first camera having a first view angle;
a second camera having a second view angle that is smaller than the first view angle;
a display;
a memory; and
a processor configured to:
apply a first tuning parameter to first image data obtained by the first camera;
recognize an external object;
control, by driving the second camera, a center of the second view angle to be oriented toward the recognized external object; and
apply, to the first image data, a second tuning parameter corresponding to a location of the center of the second view angle.

2. The electronic device of claim 1, wherein the processor is further configured to, based on the first camera being set to a specified magnification or more, apply the second tuning parameter to the first image data.

3. The electronic device of claim 1, wherein the processor is further configured to:
divide the first view angle into a plurality of sections; and
store, in a lookup table of the memory, the second tuning parameter corresponding to each of the plurality of sections.

4. The electronic device of claim 3, wherein the processor is further configured to, based on a movement of the center of the second view angle, obtain the second tuning parameter from the lookup table.

5. The electronic device of claim 1, wherein the processor is further configured to, while applying the second tuning parameter to the first image data, apply a third tuning parameter to second image data obtained by the second camera.

6. The electronic device of claim 1, wherein the processor is further configured to output a preview image to the display, the preview image representing the first image data to which the second tuning parameter is applied.

7. The electronic device of claim 6, wherein the processor is further configured to, based on a specified condition related to switching of the first camera and the second camera occurring, output the preview image to the display according to second image data obtained by the second camera.

8. The electronic device of claim 1, wherein the processor is further configured to output a preview image to the display, the preview image representing second image data obtained by the second camera.

9. The electronic device of claim 8, wherein the processor is further configured to, based on a specified condition related to switching of the first camera and the second camera occurring, output the preview image to the display, the preview image representing the first image data to which the second tuning parameter is applied.

10. The electronic device of claim 1, wherein the processor is further configured to, based on the external object being recognized beyond a specified range from a center of the first view angle, apply the second tuning parameter to the first image data.

11. The electronic device of claim 1, wherein the second camera comprises a folded camera structure comprising a prism, and
wherein the processor is further configured to control, by driving the second camera, at least one of movement and rotation of the prism of the second camera.

12. The electronic device of claim 1, wherein the processor is further configured to control, by driving the second camera, the second view angle to be within the first view angle.

13. The electronic device of claim 1, wherein each of the first tuning parameter and the second tuning parameter comprises a parameter related to at least one of noise reduction (NR), edge enhance, or multi-frame merge.

14. The electronic device of claim 1, wherein each of the first tuning parameter and the second tuning parameter comprises a deep learning model related to sharpness.

15. An image processing method performed by an electronic device, the image processing method comprising:
applying a first tuning parameter to first image data obtained by a first camera of the electronic device;
recognizing an external object;
controlling, by driving a second camera of the electronic device, a center of a second view angle of the second camera to be oriented toward the recognized external object; and
applying, to the first image data, a second tuning parameter corresponding to a location of the center of the second view angle.

16. The method of claim 15, wherein the applying of the second tuning parameter to the first image data includes:
based on the first camera being set to a specified magnification or more, applying the second tuning parameter to the first image data.

17. The method of claim 15, further comprising:
outputting a preview image to the display, the preview image representing the first image data to which the second tuning parameter is applied.

18. The method of claim 17, further comprising:
based on a specified condition related to switching of the first camera and the second camera occurring, outputting the preview image to the display according to second image data obtained by the second camera.

19. The method of claim 15, further comprising:
outputting a preview image to the display, the preview image representing second image data obtained by the second camera.

20. The method of claim 19, further comprising:
based on a specified condition related to switching of the first camera and the second camera occurring, outputting the preview image to the display, the preview image representing the first image data to which the second tuning parameter is applied.
